(19) United States
(12) Patent Application Publication
(10) Pub. No.: US 2008/0074976 A1
(43) Pub. Date: Mar. 27, 2008

(54) OPTICAL PICK-UP

(75) Inventors: Hiroshi NISHIKAWA, Saitama (JP); Suguru TAKISHIMA, Tokyo (JP); Ryosei HONMA, Tokyo (JP); Hiroshi KANAZAWA, Saitama (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/862,340

(22) Filed: Sep. 27, 2007

(30) Foreign Application Priority Data
Sep. 27, 2006 (JP) 2006-262639

(51) Int. Cl. G11B 5/09

(52) U.S. Cl. 369/53.17

(57) ABSTRACT

According to an aspect of the invention, there is provided an optical pick-up for an optical disc drive, which is provided with an objective lens configured to converge a laser beam emitted from a laser source on a recording surface of an optical disc, spherical aberration caused by the objective lens being compensated at a predetermined setting temperature of the objective lens, a heating unit configured to be driven to heat the objective lens, a spherical aberration detection unit which detects amount of spherical aberration caused by the objective lens, and a driving unit that drives the heating unit in accordance with the amount of the spherical aberration detected by the spherical aberration detection unit, the driving unit driving the heating unit when the spherical aberration detected by the spherical aberration detection unit is positive, the driving unit stopping driving the heating unit when the spherical aberration is zero or negative.

### BACKGROUND OF THE INVENTION

The present invention relates to an optical pick-up which emits laser beam to an optical disc for writing information on a recording surface and/or reading information recorded on the recording surface.

An optical pick-up is generally used in various optical disc drives configured to read out information recorded on an optical disc such as a CD (Compact Disc) or a DVD (Digital Versatile Disc) and/or write information on the optical disc. Generally, the optical pick-up is configured to receive a laser beam emitted by a laser source and converge the laser beam onto a recording surface of an optical disc.

A size of each pit formed on the optical disc is the same order of a wave length of the laser beam to be used in order to maximize recording density on the optical disc. For this purpose, it is known that spherical aberration meets a certain requirement, which is known as Marechal's limit. According to Marchal's limit, the spherical aberration (RMS)<0.07λ. When this requirement is met, a desired optical performance can be achieved.

Recently, in order to make the entire optical pick-up to be lightweight and reduce manufacturing cost of the optical pick-up, a plastic single-element lens is typically used as an objective lens of an optical pick-up for DVD/CD. According to the Blu-ray Disc standard, which is a standard for a next generation DVD, a 0.85 NA (Numerical Aperture) lens is employed. However, in order to achieve such a high NA with a single-element plastic lens, generation of spherical aberration becomes significantly large as the temperature changes. When the objective lens is in a state that the wavefront aberration caused thereby is zero at a certain temperature, and if the temperature of the objective lens changes by around 20 degrees (in Celsius), the spherical aberration may easily exceed the Marechal's limit.

Conventionally, in order to deal with the above deficiency, there is proposed an optical pick-up which is configured such that parallel light incident on the objective lens is directed to a beam expander. A moveable lens of the beam expander is moved in accordance with the temperature change so that spherical aberration caused by the objective lens is compensated so that the degree of the spherical aberration is within the Marechal's limit. An example of such a configuration is disclosed in “O PLUS E”, p405, No. 4, Vol. 27, April, 2005, Shin-Gijutsu Communications.

However, the technology described in the above publication has a configuration where an objective lens is designed so that wavefront aberration becomes zero at a specific setting temperature, and when an actual temperature of the objective lens is shifted from the specific temperature, a movable lens of a beam expander is moved according to a temperature change (an amount of spherical aberration generated by the shift of the temperature change). Therefore, a driving mechanism for moving the beam expander is necessary. As a result, the mechanism causes a manufacturing cost to increase due to a larger number of assembly parts and/or machine adjustment process, relatively heavy weight of a carriage and accompanying poor response in tracking operation.

### SUMMARY OF THE INVENTION

In consideration of the above, the present invention is advantageous in that there is provided an optical disc drive with which generation of spherical aberration can be well suppressed, and a driving mechanism for a beam expander to compensate for the spherical aberration which varies in accordance with change of temperature from its initial temperature to a predetermined temperature, and is capable of bringing the optical disc drive in a steady state in a relatively short time.

According to an aspect of the invention, there is provided an optical pick-up for an optical disc drive, which is provided with an objective lens configured to converge a laser beam emitted from a laser source on a recording surface of an optical disc, spherical aberration caused by the objective lens being compensated at a predetermined setting temperature of the objective lens, a heating unit configured to be driven to heat the objective lens, a spherical aberration detection unit which detects amount of spherical aberration caused by the objective lens, and a driving unit that drives the heating unit in accordance with the amount of the spherical aberration detected by the spherical aberration detection unit, the driving unit driving the heating unit when the spherical aberration detected by the spherical aberration detection unit is positive, the driving unit stopping driving the heating unit when the spherical aberration is zero or negative.

According to the above configuration, a designer of an objective lens sets a setting temperature at which the spherical aberration caused by the objective lens may be minimized. The spherical aberration may be caused while the temperature of the objective lens is in a transition state (i.e., the temperature of the objective lens is lower than the setting temperature) just after laser beam begins to be emitted. To deal with this problem, magnitude of the spherical aberration is detected and the temperature of the objective lens is raised by applying heat so that the temperature of the objective lens reaches the setting temperature that corresponds to the steady state within a short time. With this configuration, a beam expander and a driving mechanism therefor become unnecessary.

### BRIEF DESCRIPTION OF THE ACCOMPANYING DRAWINGS

FIG. 1 is a perspective view of an entire optical disc drive according to the first embodiment of the invention.

FIG. 2 is an illustration which shows an optical configuration of optical parts that consist the optical pick-up and a circuit block.

FIG. 3 is a perspective view of the optical pick-up shown in FIG. 2.

FIG. 4A is a plan view of a objective lens and a lens holder. FIG. 4B is a longitudinal cross-section view along a line X-X shown in FIG. 4A.

FIG. 5 is a graphic chart which shows correlation between coil current supplied to a heater and spherical aberration.

FIG. 6A is a plan view of an objective lens and a lens holder in the first alternative embodiment of the first embodiment. FIG. 6B is a longitudinal cross-section view along a line X-X shown in FIG. 6A.

FIG. 7A is a plan view of an objective lens and a lens holder in the second alternative embodiment of the first embodiment. FIG. 7B is a longitudinal cross-section view along a line X-X shown in FIG. 7A.

FIG. 8 is an illustration which shows an optical configuration of optical parts that consist the optical pick-up according to the second embodiment of the invention and a circuit block.

FIG. 9 is a perspective view of the optical pick-up shown in FIG. 8.

FIG. 10A is a plan view of the objective lens and the lens holder shown in FIG. 8. FIG. 10B is a longitudinal cross-section view along a line X-X shown in FIG. 10A.

FIG. 11A is a plan view of the objective lens and the lens holder in the first example of variation of the second embodiment. FIG. 11B is a longitudinal cross-section view along a line X-X shown in FIG. 11A.

FIG. 12A is a plan view of the objective lens and the lens holder in the second example of variation of the second embodiment. FIG. 12B is a longitudinal cross-section view along a line X-X shown in FIG. 11A.

FIG. 13 is an illustration which shows an optical configuration of optical parts that consist the optical pick-up according to the second embodiment of the invention and a circuit block.

FIG. 14 is a perspective view of the optical pick-up shown in FIG. 13.

FIG. 15 is a view of the objective lens actuator, with parts broken away for the sake of clarity.

FIG. 16A is a plan view of an objective lens and a lens holder in the third embodiment. FIG. 16B is a longitudinal cross-section view along a line X-X shown in FIG. 16A.

FIG. 17A is a longitudinal cross-section view which shows a status of playing the first recording layer of the single-side dual-layer disc. FIG. 17B is an enlarged fragmentary view of FIG. 17A.

FIG. 18A is a longitudinal cross-section view which shows a status of playing the second recording layer of the single-side dual-layer disc. FIG. 18B is an enlarged fragmentary view of FIG. 18A.

### DETAILED DESCRIPTION OF THE EMBODIMENTS

### First Embodiment

Hereinafter, an optical pick-ups according to embodiments of the invention will be described with reference to the accompanying drawings.

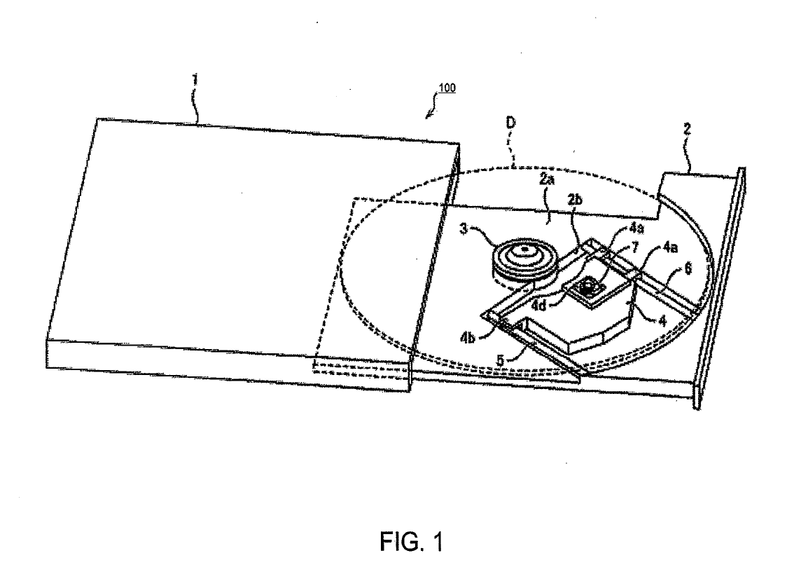

FIG. 1 is a perspective view of an optical disc drive 100 according to the embodiment of the invention. As shown in FIG. 1, the optical disc drive 100 includes a thin box-type casing 1 which is to be assembled in a personal computer (not shown), a video recorder or the like, and a tray 2 which is ejectable/retractable with respect the casing 1. When the tray 2 is ejected from the casing 1, an optical disc D can be mounted or dismounted. When the tray 2 is retracted into the casing 1, the tray 2 is completely accommodated in the casing 1 and an opening of the casing 1, through which the tray 2 is ejected, is closed.

Further, according to the embodiment, in order to make the entire optical disc drive 100 thin, major components such as a spindle 3 and a carriage 4 to perform essential functions of the optical disc drive 100 are mounted on the tray 2. It should be noted that some thin-type optical disc drives adopted for so-called note-type personal computers may be configured such that the spindle and the carriage may be mounted on a casing and a upper plate thereof may be configured as an openable/closable lid. The present invention can also be applied to such devices.

In the optical disc drive 100 shown in FIG. 1, a disc mounting part 2a is formed on the upper surface of the tray 2 as a concave portion which has formed to receive the optical disc D and allows the optical disc D to rotate without interference. A spindle 3 is positioned at the center of the disc mounting part 2a. The spindle 3 is rotated by a direct drive motor including shaft which clamps the optical disc D by engaging into a central hole of the disc. As a result, the spindle 3 rotates the optical disc D as the direct drive motor is actuated.

The carriage 4 has an optical pick-up which is built in the carriage. The optical pick-up is provided in a rectangular opening 2b, which is formed on a bottom surface of the disc mounting part 2a, and held slidably by two rails 5 and 6 extending so that the carriage 4 slides in the radial direction. That is, both the rails 5 and 6 are built over the opening 2b, parallel to a transition trajectory of an objective lens 7, which extends in the radial direction from the spindle 3. The rail 6 penetrates a pair of guide followers 4a which protrude from one of edges of the carriage 4. A fork 4b protrudes from the other edge, and the other rail 5 is nipped by a pair of arms of the fork 4b. As a result, the carriage 4 slides within the opening 2b so that the objective lens 7 moves along the direction of a radius which extends from the spindle 3 (i.e., the objective lens moves in the tracking direction of the optical disc D). Since it is a well-known structure, it is not shown in the figure but a rack is formed at the tip of the guide follower 4a, while a worm gear engaging with the rack is provided to extend parallelly to the rail 6 inside the corresponding opening 2b. Therefore, the worm gear (not shown) is driven to rotate by the motor (not shown), and the position of the carriage 4 is controlled.

An window 4d is bored to expose the objective lens 7 included in the optical pick-up on the upper surface of the carriage 4. A cavity to store the carriage 4 is formed inside the optical pick-up.

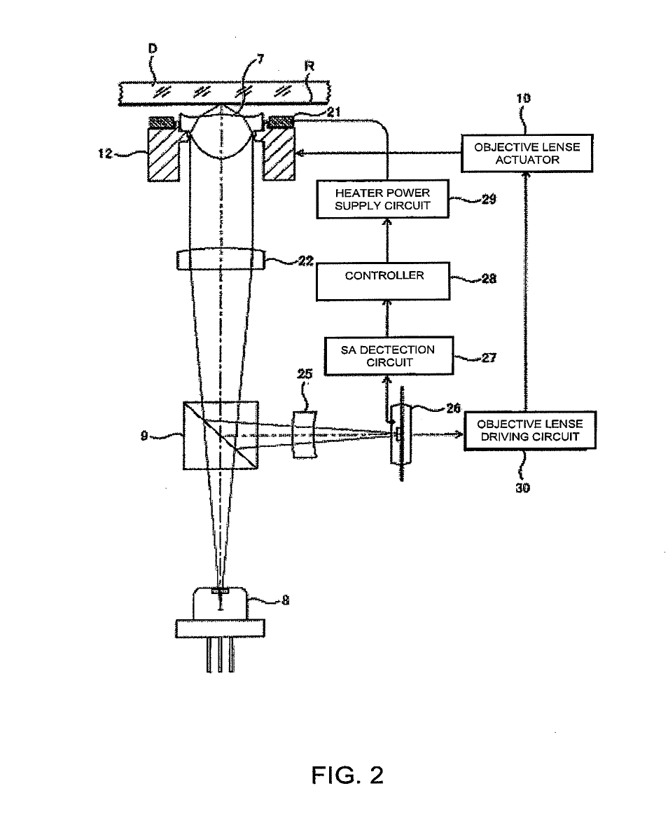

FIG. 2 schematically shows an optical configuration of optical parts included in the optical pick-up and circuit blocks of the control system of the optical pick-up. Here, a reflective member such as a reflecting mirror and a refractive member such as a prism are not shown, and a light path is developed.

Optical parts include a laser beam source 8, a beam splitter 9, a collimating lens 22, an objective lens 7, a sensor lens 25, and a light receiving device 26.

The laser beam source 8 emits a laser beam of blue-violet bandwidth (405 nm) conforming to the Blu-ray Disc standard.

The beam splitter 9 is provided in the light path of the laser beam emitted from the laser beam source 8. The beam splitter is a prism (polarization beam splitter) which transmits the laser beam emitted by the laser beam source 8 and reflects the light reflected by the optical disc D toward the sensor lens 25.

The collimating lens 22 is a positive lens which collimates the incident laser beam, which is emitted from the laser beam source 8 and transmitted through the beam splitter 9.

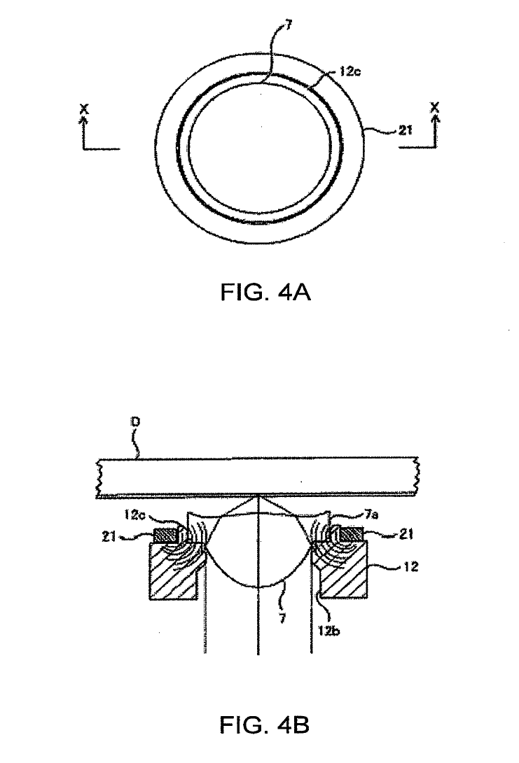

The objective lens 7 is a converging lens (positive lens) which converges the laser beam transmitted through the collimating lens 22 onto a recording layer R of the optical disc D. The objective lens 7 is a plastic single-element lens. The numerical aperture (NA) thereof at a design temperature is 0.85, conforming to the Blu-ray disc standard. FIG. 4B is a cross-sectional view of the objective lens 7 along a line X-X shown in FIG. 4A. As shown in the cross-sectional view, an outer periphery of the objective lens 7 is formed with a flange 7a, which is an outwardly protruded annular part.

The laser beam converged onto the recording layer R and reflected thereby proceeds toward the objective lens 7 as a diverging modulation light carrying information recorded on the recording layer R. The modulation light incident on the objective lens 7 is emerged therefrom as parallel light if the temperature is equal to a setting temperature. The light emerged from the objective lens 7 is then incident on the collimating lens 22. Since the incident light is parallel light, the laser beam is converged by the collimating lens 22 and enters the beam splitter 9. A part of the laser beam is reflected by the beam splitter 9 and enters a sensor lens (cylindrical lens) 25. The sensor lens 25 converges the entered beam on a light receiving device 26 (the incident beam being converged in one direction). It should be noted that the setting temperature of the objective lens 7 is a temperature of the objective lens 7 in the carriage 4 after the temperature thereof has been raised with a continuously incident laser beam and the temperature is in a steady state. The setting temperature is dependent on heat conductance of materials of components of the carriage 4 and condition of ventilation around the carriage 4.

The objective lens 7 is designed so that the lens achieves prescribed performance at such a setting temperature and converges the laser beam without generating spherical aberration. Therefore, at a room temperature (around 25 degrees Celsius), positive spherical aberration is exhibited on a beam spot formed by the objective lens 7.

The above described light receiving device 26 detects an overall light amount of the received light, transmits the amount as a regeneration signal to an output circuit (not shown). Further, the light receiving device 26 detects an amount of spherical aberration in the received light. In order to realize such a function, the light receiving device 26 has a publicly known configuration. That is, the light receiving device 26 may include hologram and a plurality of light receiving elements as is described in United States Patent Application Publication No. US 2004/0264341 A1, teachings of which are incorporated herein by reference, filed by the assignee of the present invention. Then, each of the light receiving elements forming the light receiving device 26 inputs an analog signal representing a light amount of light which is received by the individual element into an SA (spherical aberration) detection circuit 27.

The SA detection circuit 27 generates a digital signal which represents an amount of spherical aberration generated in the beam spot which is formed by the objective lens 7 as a numerical value based on the input analog signals and inputs the digital signal into a controller 28.

Further, the light receiving device 26 is also configured to transmit an analog signal representing the amount of the light received by each of the light elements received as a tracking signal and a focusing signal to an objective lens driving circuit 30.

The objective lens driving circuit 30 calculates a moving amount of the objective lens 7 to cancel deviance of the spot of the laser beam (beam waist) on the recording surface R of the optical disc D based on a status of laser beam indicated by the focusing signal transmitted from the light receiving device 26. By controlling the objective lens actuator 10 based on the calculated moving amount, the objective lens driving circuit 30 adjusts the position (focusing) of the objective lens 7 in the direction of the optical axis so that a spot of the laser beam (beam waist) is formed on the recording surface R of the optical disc D. Further, the objective lens driving circuit 30 precisely adjusts the position of the objective lens 7 in the tracking direction (the radial direction of the optical disc D clamped by the spindle 3) based on the tracking signal transmitted from the light receiving device 26 by controlling the objective lens actuator 10, in order to realize a high-precision tracking by fine adjustment of tracking error (i.e., by canceling remaining error by the low precision due to above described movement of the entire carriage 4).

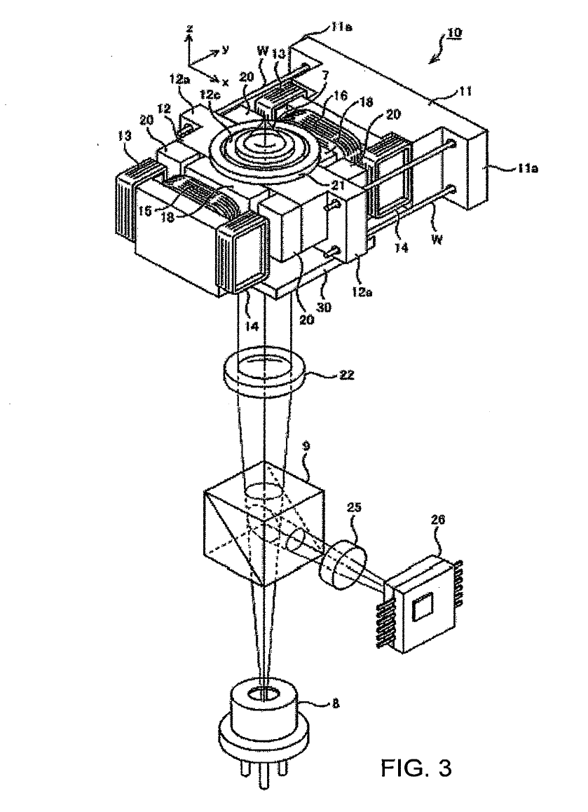

FIG. 3 is a perspective view of the objective lens actuator 10. In FIG. 3, an arrow z shows a direction parallel to an optical axis of the objective lens 7 (i.e., a direction perpendicular to the optical disc D clamped by the spindle 3, hereinafter, referred to as a “z-direction”). An arrow x shows a tracking direction (i.e., a direction which the entire carriage 4 moves, hereinafter, referred to as an “x-direction”). An arrow y shows a direction perpendicular to both the z direction and the x-direction (hereinafter, referred to as a “y-direction”).

As shown in FIG. 3, the objective lens actuator 10 has:

a wire-securing mount 11 fixed inside of the carriage 4, the mount 11 having a shape of a substantially rectangular column of which longitudinal direction extends in the x-direction;

a lens holder 12 which has a shape of a substantially rectangular column of which length is almost the same of the length of the wire-securing mount 11 and is swingably held by the wire-securing mount 11 via 4 wires W, longitudinal direction of the lens holder extending in the x-direction;

a pair of focusing magnets (permanent magnets) 18 and 18 respectively fixed on side surfaces opposing in the y-direction, at the central portions thereof;

four tracking magnets (permanent magnets) 20, each two tracking magnets 20 being fixedly provided at both sides, in the x-direction, of each focusing magnet 18 and 18;

a base 30 having a shape of a cross of which two opposing arms are bended so as to have a U-shape cross-section and is fixed inside the carriage 4 so as to surround the lens holder 12 from the tray 2 side;

focusing coils 15 and 16 fixed on the inner sides of bent portions of the base 30 (i.e., portions of the base 30 extending in the z-direction), the focusing coils 15 and 16 facing the focusing magnets 18 and 18, respectively;

four (4) tracking coils 13, 13, 14 and 14 fixed on side surfaces, which extend in the y-direction and z-direction, of the bent portions of the base 30 such that the tracking coils 13, 13 face the tracking magnets 20, respectively, and the tracking coils 14 and 14 also face the tracking magnets 20, respectively; and

a heater 21 fixed on the upper surface of the lens holder 12.

It is noted that among the above described parts, the wire-securing mount 11, the lens holder 12 and the base 30 are resin molded products.

The both ends of the wire-securing mount 11 are formed as lobes of which thickness in the y-direction is smaller than the other portion so that effective length of the wire W is sufficient.

Similarly, both ends of the lens holder 12 in the x-direction are also formed as lobes of which thickness in the y-direction is smaller so that effective length of the wire is obtained. Four wires W, of which axial directions are the y-direction (each two (a pair of) wires W being spaced in z-direction and parallelly arranged, the two pairs of parallelly arranged wires W being spaced in x-direction and parallelly arranged), are penetrated and fixed between the lobes 11a and 12a facing each of the wire-securing mount 11 and the lens holder 12. As a result, the lens holder 12 can be substantially translated both in the x-direction and the z-direction, while maintaining the position of optical axis of the objective lens 7 in the z-direction. It is noted that the four wires W are also serve as electric power supply lines for supplying electric power to the heater 21.

The objective lens 7 is fitted in an optical disc side of a penetrated opening 12b which is penetrated along the z-direction at the center of the lens holder 12. The flange 7a of the objective lens contacts the end of the portion of the lens holder 12 defining the penetrated opening 12b and the position in the optical axis direction is adjusted. As shown in FIG. 4B, on the upper surface of the lens holder 12, surrounding the penetrated opening 12b and the flange 7a of the objective lens 7, a cylindrical frame 12c limiting movement of the objective lens 7 in the radial direction is integrally formed. The above-described heater 21 is configured with Nichrome wire which is wound to form a coil and fixed to surround the frame 12c.

Based on an amount of spherical aberration input by the SA detection circuit 27, the above described controller 28 refers to a reference table (not shown) and reads out an electrical current value corresponding to the amount of spherical aberration. The reference table relates the amount of spherical aberration to the current value such that the current value is larger as the amount of spherical aberration is larger in positive side, and if the amount of spherical aberration is zero or in negative side, the current value is zero. Then, the controller 28 controls the heater power supply circuit 29 to supply the electrical current to the heater 21 so that the electrical current of which value is the current value read out from the reference table is supplied (or the current supply is stopped).

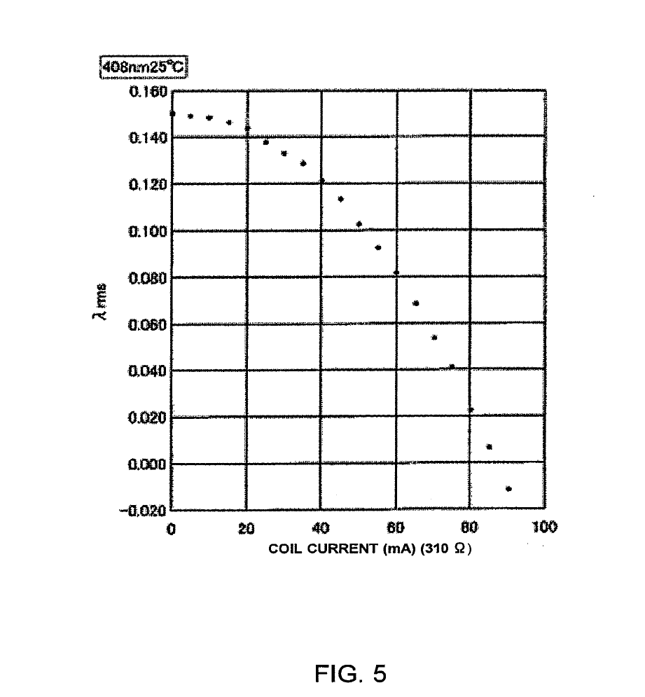

FIG. 5 is a graphic chart in which a relationship between the amount of spherical aberration [λ rms] exhibited by the objective lens 7 at the wave length of the laser beam is 408 nm and the temperature of the objective lens 7 (which is rising gradually) is shown. Specifically, in this exemplary embodiment, to the heater placed in the room temperature (25 degrees Celsius), an electrical current which is gradually increased from 0 [mA] is supplied. The graphic chart shows a tendency that as larger the current value [mA] supplied to the heater 21 becomes, the more the temperature of the objective lens 7 rises, and spherical aberration generated by the objective lens 7 changes to a negative side. In the graphic chart, the electrical current value corresponding to the state where spherical aberration is 0 [λ rms] indicates a current value which raises the temperature of the objective lens 7 to the setting temperature.

According to the optical drive device of the embodiment of the invention, when each of the coils 13-16 is not supplied with a driving current just after the laser beam source 8 begins to emit laser beam, a temperature of the objective lens 7 is substantially the same as the room temperature, which is much lower than the setting temperature. Therefore, inevitability, spherical aberration on the positive side is generated in the laser beam converged by the objective lens 7. The spherical aberration thus generated is detected by the SA detection circuit 27 via the light receiving sensor 26, and amount of the spherical aberration is input to the controller 28. Then, the controller 28 controls the heater power supply circuit 29 so that the current corresponding to the amount of the spherical aberration is supplied to the heater 21. As a result, the heater 21 to which the current is supplied generates heat, and the temperature of the objective lens 7 rises. Then, the amount of the spherical aberration caused by the objective lens 7 is reduced. Through the above-described cycle, the temperature of the objective lens 7 reaches the setting temperature in due time, and the amount of the spherical aberration caused by the objective lens becomes zero. Once, as described above, the amount of the spherical aberration becomes zero, the controller 28 controls so that the current supply to the heater 21 is stopped. Although the heater 21 stops generating the heat, the temperature of the objective lens 7 is maintained at the setting temperature by heat generated by the laser beam itself, heat generated by the laser beam source 8, and heat generated by each of the coils 13-16. Therefore, after that, spherical aberration will not be caused by the objective lens 7.

(Modification)

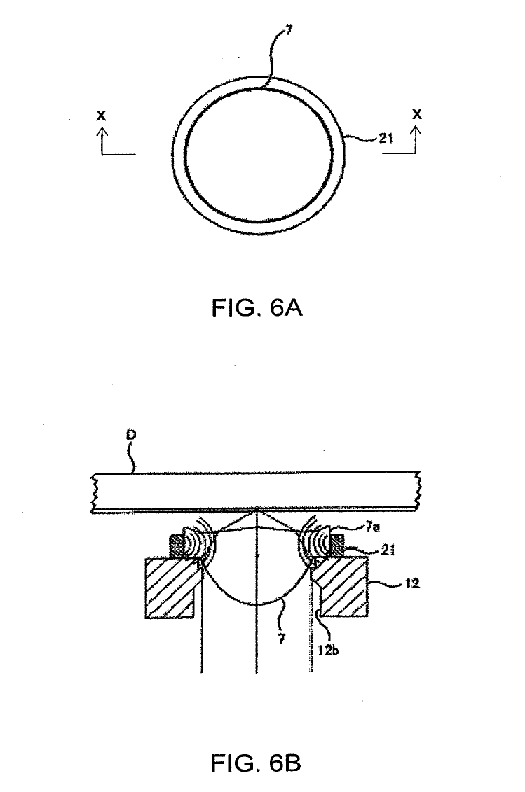

FIG. 6A is a plan view of the lens holder 12 and the objective lens 7 in the first modification of the first embodiment. FIG. 6B is a longitudinal cross-section view along a line X-X shown in FIG. 6A. That is, by omitting the frame 12c from the lens holder 12, the modification makes the heater 21 be contacted directly with a surrounding surface of the flange 7a of the objective lens 7 and make it more effective to heat the objective lens 7 than the example of the first embodiment shown in FIG. 4. (Alternative Embodiment 2)

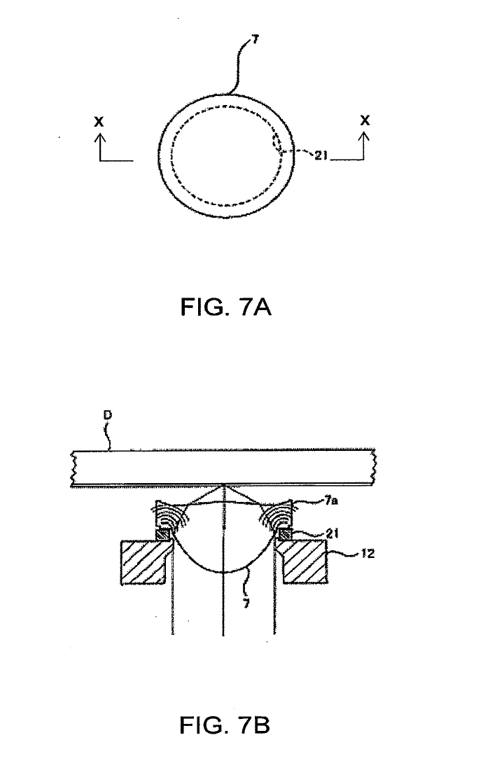

FIG. 7A is a plan view of the lens holder 12 and the objective lens in the second modification of the first embodiment. FIG. 7B is a longitudinal cross-section view along a line X-X shown in FIG. 7A. That is, similar to the above first modification, the objective lens 7 directly contacts the heater 21 and generates heat. Differently from the first modification, the heater 21 is placed between the flange 7a of objective lens 7 and the lens holder 12.

### Second Embodiment

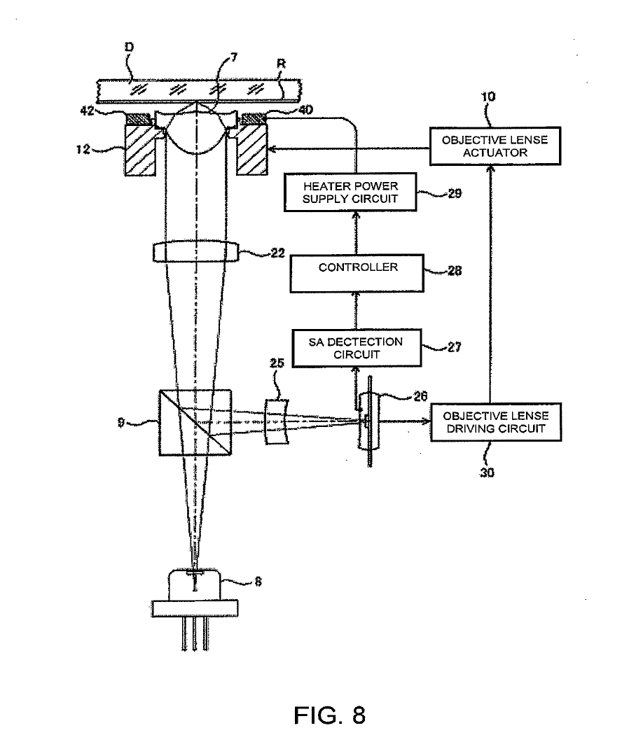

Next, a second embodiment according to the invention will be described. Compared to the first embodiment, the second embodiment is different in that the heater 21 is divided into four heater elements 40-43, and each of the four elements is configured to generated heat individually. Each of FIGS. 8-10, which shows a configuration of the second embodiment corresponds to each of FIG. 2-4 relating to the above described first embodiment.

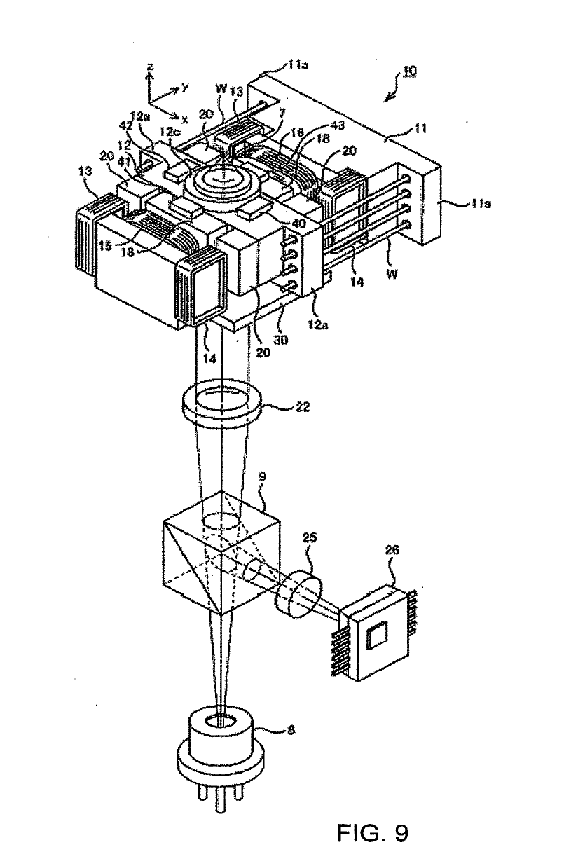

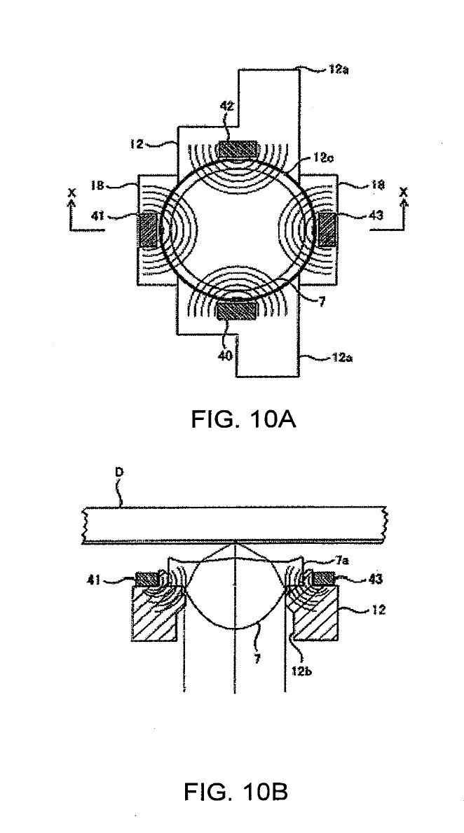

Layouts of the heater elements 40-43 on the upper surface of the lens holder 12 in the second embodiment are shown in FIG. 9 and FIG. 10. That is, in the second embodiment, similar to the first embodiment shown in FIG. 3 and FIG. 4, a lens holder with a frame 12c is used. Then, the heater elements 40-43 which are rounded to have a outer shape of quasi-rectangular solid are fixed individually on four edges of the frame 12c on the upper surface of the lens holder 12 (i.e., on each of the focusing magnets 18, 18 and positions next to the frame 12c in the x-direction).

The four heaters 40-43 separated from each other as described above are individually supplied with driving currents from the heater power supply circuit 29 shown in FIG. 8. Thereby, a wire W which is also a supply source of the driving currents to each of the heater elements 40-43 configured with 4 wire elements for each (8 wires in total) that are bridged between each lobes 11a of the wire-securing mount 11 and the lobes 12a of the lens holder 12.

The heater power supply circuit 29 determines an heat amount of each of the heater 40-43 suitable to compensate for spherical aberration corresponding to the value of spherical aberration input from the controller 28 and supplies currents corresponding to the determined heat amount to each of the heater elements.

According to the second embodiment, comparing to the first embodiment, more suitable management of the temperature of the objective lens 7 is possible.

Since the other configurations and the effects thereof in the second embodiment are the same as the configurations and the effects in the first embodiment, the explanation is omitted for brevity.

(Modification 1)

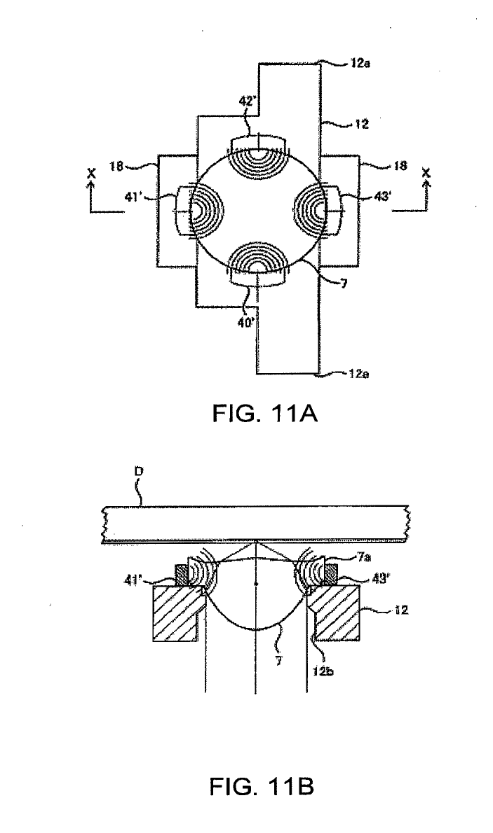

FIG. 11A is a plan view of the lens holder and the objective lens in the first modification of the second embodiment. FIG. 11B is a longitudinal cross-sectional view along a line X-X shown in FIG. 11A. That is, by omitting the frame 12c from the lens holder 12, the modification makes the heater 21 directly contact the surrounding surface of the flange 7a of the objective lens 7 and makes it more effective to heat the objective lens 7 than the example of the second embodiment shown in FIG. 10. Thereby, each of the heater elements 40-43 according to the first modification are curved be arc-shaped. It is noted that an inner surface has the same curvature as curvature of the surrounding surface of the flange 7a of the objective lens 7. As a result, since the inner surfaces of the heat elements closely contact the surrounding surface of the flange 7a of the objective lens 7, it is possible to heat the objective lens 7 effectively.

(Modification 2)

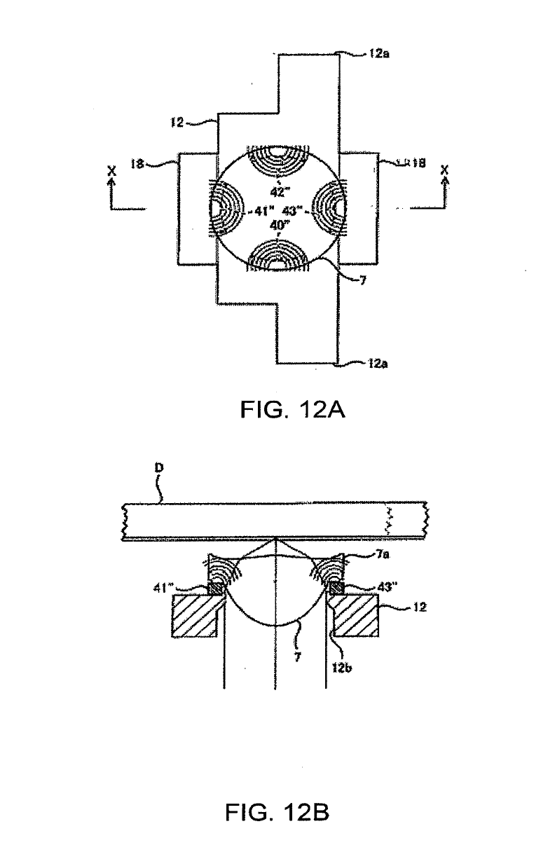

FIG. 12A is a plan view of the lens holder 12 and the objective lens 7 according to a second modification of the second embodiment. FIG. 12B is a longitudinal cross-sectional view along a line X-X shown in FIG. 12A. That is, similar to the first modification, the objective lens 7 directly contacts the heater elements 40-43 and generates heat. Differently from the first modification, the heater elements 40-43 are placed between the flange 7a of objective lens 7 and the lens holder 12. Thereby, each of the heater elements 40-43 according to the second modification are curved to be arc-shaped with an inner surface having the same curvature as curvature of the surrounding surface of the flange 7a of the objective lens 7.

### Third Embodiment

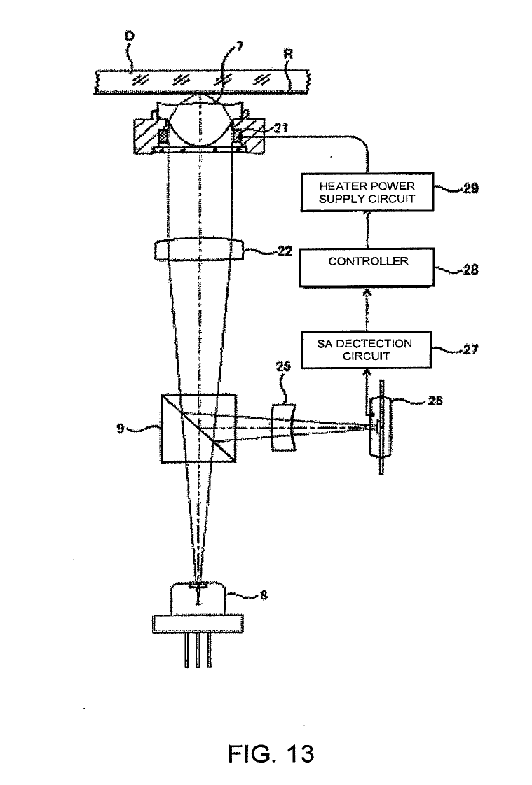

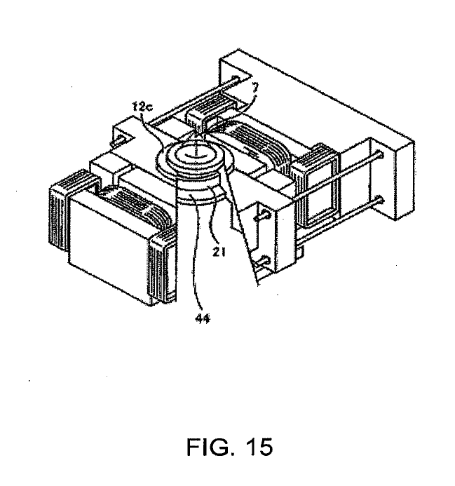

A third embodiment according to the invention will be described. Compared to the first embodiment, the configuration of the third embodiment is different in that the heater 21 is installed inside the penetrated opening 12b and the light source side end of the penetrated opening 12b is closed with a cover glass 44. Each of FIGS. 13, 14 and 16 which shows a configuration of the third embodiment corresponds to each of FIG. 2-4 relating to the above described first embodiment. Further, FIG. 15 is a view of the objective lens actuator 10, with parts broken away for the sake of clarity and shows the interior of the penetrated hole 12b of the lens holder.

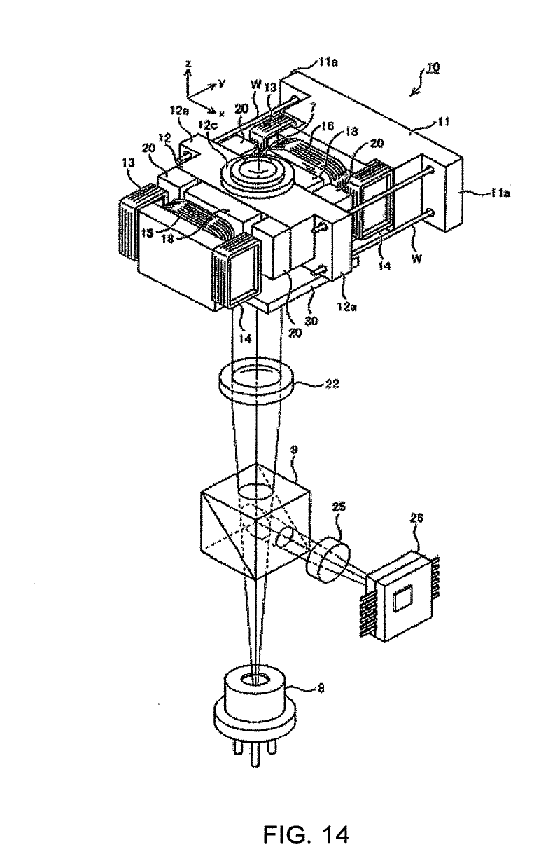

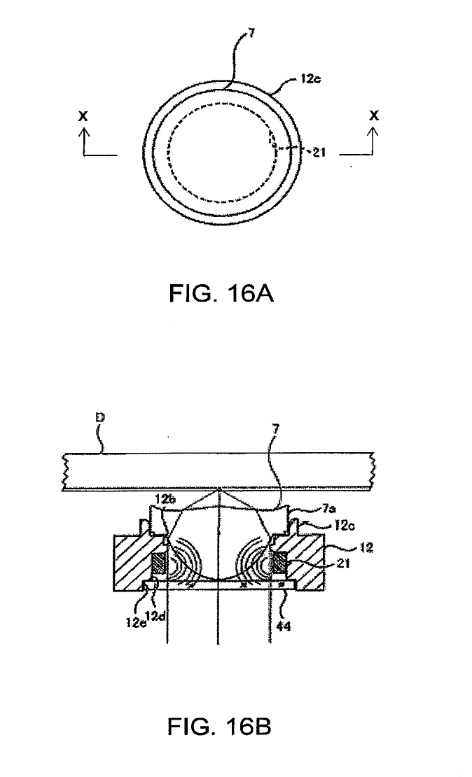

As shown in FIG. 14, on the upper surface of the lens holder 12, no heater, etc., is installed. Instead, as shown in FIG. 15 and FIG. 16, on the inner surface of the penetrated opening 12b of the frame 12c, only vicinity of the opening end on the disc side (upper side in FIG. 16B) has a inner diameter which is almost the same as a diameter of the bordering edge of lens surface of the objective lens 7 and the flange 7a (i.e., a diameter of the laser beam). In the portion on the light source side (lower portion in the FIG. 16B ), the inner surface has a larger inner diameter 12d which the inner diameter is enlarged by the thickness of the heater 21. Vicinity of the opening end on the light source side has a counterbore portion 12e with a further enlarged inner diameter.

The heater 21 is configured with Nichrome wire which is coiled in an annular shape that has an outside diameter which is nearly the same as a large inner diameter of the penetrated opening 12b of the lens holder 12 and a little larger than a beam diameter of the laser beam. The heater 21 is fixed by being intruded into the inner diameter portion 12d of the penetrated hole 12b.

The cover glass 44 is a disk-shaped parallel plane glass which has an outside diameter nearly equal to the inner diameter of the counterbore portion 12e of the penetrated hole 12b of the lens holder 12. The cover glass 44 is intruded into the counterbore portion 12e and is fixed. A space within the penetrated hole is sealed.

According to the third embodiment configured as described above, since the inner space of the penetration opening 12b is sealed by the objective lens 7 and the cover glass 44, heat generated by the heater 21 is transferred to the objective lens 7 also by convective flow and radiation of heat besides thermal conduction which is a heat transfer type in the first embodiment and the second embodiment.

Therefore, according to the third embodiment, since heating efficiency of the objective lens 7 is improved in comparison with cases of the first embodiment and the second embodiment, the temperature rising of the objective lens 7 to the setting temperature is completed faster.

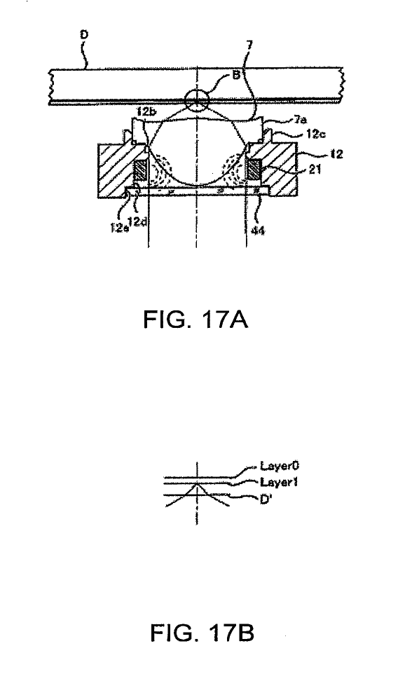

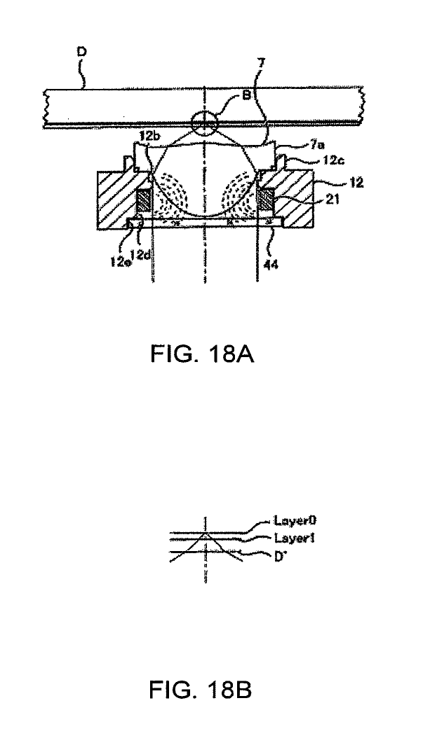

Further, as described above, since the temperature rising of the objective lens is completed faster, using the change of refraction index of the medium due to the temperature change, it is possible to switch focal length of the objective lens 7, and switch a playing layer of a single-side dual-layer disc. That is, in the case, two kinds of setting temperatures are prepared. The objective lens is designed so that in the first setting temperature which is relatively low, as shown in FIG. 17B of enlarged figure of the portion that is indicated by the circle B in FIG. 17A, laser beam is converged on a first recording layer (Layer 1) of a single-side dual-layer disc D, and spherical aberration becomes zero, and in the second setting temperature which is relatively high, as shown in FIG. 18B of enlarged figure of the portion that is indicated by the circle B in FIG. 18A, laser beam is converged on a second recording layer (Layer 2) of a single-side dual-layer disc D, and spherical aberration becomes zero. Then, in the case that a single-side dual-layer disc is played, firstly, the objective lens 7 is heated up to the first setting temperature, then it is possible to play data recorded on the first recording layer (Layer 1) by converging laser beam onto the first recording layer (Layer 1). Thus, when data recorded in the first recording layer (Layer 1) is finished to be played, by heating the objective lens 7 up to the second setting temperature, and converging the laser beam on the second recording layer (Layer 0), data recorded on the second recording layer (Layer 0) is able to be played.

Since the other configurations and the effects of the third embodiment are the same as the configurations and the effects in the first embodiment, the explanation is skipped.

The present disclosure relates to the subject matter contained in Japanese Patent Application No. 2006-262639, filed on Sep. 27, 2006, which is expressly incorporated herein by reference in its entirety.

What is claimed is:

1. An optical pick-up for an optical disc drive, comprising:
an objective lens configured to converge a laser beam emitted from a laser source on a recording surface of an optical disc, spherical aberration caused by the objective lens being compensated at a predetermined setting temperature of the objective lens;
a heating unit configured to be driven to heat the objective lens;
a spherical aberration detection unit which detects amount of spherical aberration caused by the objective lens; and
a driving unit that drives the heating unit in accordance with the amount of the spherical aberration detected by the spherical aberration detection unit, the driving unit driving the heating unit when the spherical aberration detected by the spherical aberration detection unit is positive, the driving unit stopping driving the heating unit when the spherical aberration is zero or negative.

2. The optical pick-up according to claim 1,
further comprising a beam splitter which is arranged to receive the laser beam emitted by the laser source and conduct the laser beam toward the objective lens, the beam splitter separating reflected light of the laser beam which is reflected on the recording surface of the optical disc and transmitted through the objective lens from an optical path of the laser beam emitted by the laser source,
wherein the spherical aberration detection unit detects the amount of the spherical aberration by receiving the reflected light separated by the beam splitter.

3. The optical pick-up according to claim 2,
wherein the heating unit includes a heater configured to generate heat in accordance with magnitude of electrical current supplied to the heater, and
wherein the driving unit includes a current supply circuit configured to supply an electrical current to the heater, magnitude of the electrical current supplied to the heater being varied in accordance with the amount of the spherical aberration.

4. The optical pick-up according to claim 3, further comprising a lens holder which holds the objective lens, the heater being provided on the lens holder.

5. The optical pick-up according to claim 3, wherein the heater has an annular shape surrounding an optical path of the laser beam transmitting through the objective lens.

6. The optical pick-up according to claim 3, wherein the heater includes a plurality of heat elements which are placed to surround an optical path of the laser beam transmitting through the objective lens.

7. The optical pick-up according to claim 3, wherein the heater is installed between the objective lens and the lens holder.

8. The optical pick-up according to claim 3,
wherein the lens holder has:
a through opening, the objective lens to be intruded into one end of the through opening;
a cover glass provided at the other end of the through opening,
wherein the heater is provided in the through opening which is closed by the cover glass and the objective lens.

9. The optical pick-up according to claim 8, wherein the heater has an annular shape surrounding an optical path of the laser beam which transmits through the objective lens.

10. The optical pick-up according to claim 3, wherein the magnitude of the electrical current supplied by the current supply circuit is greater as the amount of the spherical aberration is greater.

11. The optical pick-up according to claim 1, wherein the setting temperature is normally higher than an environmental temperature of the objective lens when the optical pick-up is not used.
